(19) United States
(12) Patent Application Publication
(10) Pub. No.: US 2026/0284672 A1
(43) Pub. Date: Sep. 24, 2026

(54) DEVICE FOR CRUSHING PAVING STONES AND/OR KERB STONES

(71) Applicant: Baustoffwerke Gebhart & Soehne GmbH & Co. KG, Lachen (DE)

(72) Inventors: Hans Gebhart, Lachen (DE); Franz Pfeiffer, Lachen (DE); Gordian Gebhart, Lachen (DE)

(73) Assignee: Baustoffwerke Gebhart & Soehne GmbH & Co. KG, Lachen (DE)

(21) Appl. No.: 19/121,296

(22) PCT Filed: Oct. 18, 2023
(86) PCT No.: PCT/EP2023/079054

§ 371 Date: Apr. 15, 2025

(30) Foreign Application Priority Data
Oct. 19, 2022 (DE) 10 2022 127 601.5

(51) Int. Cl. B02C 23/02; B65G 47/14

(52) U.S. Cl. CPC B02C 23/02; B65G 47/1421

(57) ABSTRACT

The invention relates to a device (10) for crushing paving stones and/or kerb stones, in particular made of concrete or concrete-like material, comprising: at least one first crusher (200) with driven crusher elements for crushing the paving and/or kerb stones to be crushed, wherein the crusher has a supply opening via which the paving and/or kerb stones to be crushed are separately supplied to the driven crusher elements; at least one vibration conveyor unit, associated with the first crusher (200), for conveying and separating the paving and/or kerb stones to be crushed, and which are supplied in the form of bulk material, in a conveying direction; wherein the vibration conveyor unit (100) comprises at least two vibration channels, which are arranged one after another in relation to the conveying direction of the device (10) and define a channel-shaped receiving space (130) for the paving and/or kerb stones to be crushed.

### PRIORITY

The present application claims the priority of German patent application No. 10 2022 127 601.5, the content of which is fully incorporated herein by reference.

### FIELD OF THE DISCLOSURE

The invention relates to an apparatus for crushing paving stones and/or kerbstones, in particular made of concrete or concrete-like material. The apparatus according to the invention can also be used for crushing what are referred to as block steps, in particular made of concrete or concrete-like material.

### BACKGROUND

Mobile apparatuses are used for crushing paving stones and/or kerbstones, for example in order to recycle building rubble. Such mobile crusher plants are moved when required to the location at which the rubble be crushed is stored and swiftly crush all of the material to be crushed to a predetermined particle size (grain size), for example for a screen passage of 0 mm to 50 mm. The grain size of a crushed particle is the smallest diameter thereof that, in the case of a screen with a predetermined sieve passage, for example, of 7 mm, would pass through the screen.

The mobile crusher plants used make use of different types of crushers, for example cone crushers or the like. A common feature of many mobile crusher plants is that they are supplied when required, i.e. at regular intervals, for example once a year, in case of regularly occurring rubble, or upon request, in case of one-off rubble, in order to crush the rock waste, for example paving stones and/or kerbstones or building rubble, to a desired grain size. The crushing capacity of these plants is comparatively large, for example in the range of 200 to 400 kW, in order to crush the starting material in situ as quickly as possible. This procedure is customary due to the high delivery and usage costs of the mobile crusher plants. In practice, however, this is disadvantageous in particular if the starting material which is to be crushed has to be stored in the meantime from the moment it is produced until it is crushed and thus takes up a comparatively large storage space. This is the case, for example, if the building rubble which is to be crushed is not produced in a short time, as in the case of building demolition, but rather continuously in small quantities, such as in the form of scrap during the production of paving stones and/or kerbstones.

The crushed material can be recycled after being crushed to a predetermined grain size, but the crushed material has in turn to be stored until it is recycled, which takes up storage space and, in the case of crushed material made of concrete or concrete-like material, may result in the crushed material possibly starting to bind again and become hard during the interim storage period.

Accordingly, there is a need for a crusher plant that can be used at any time, i.e. continuously, unlike the mobile crusher plants that are requested when the need arises. Unlike in the case of the stationary plants which were used in the past and in which crushing was likewise carried out with a very high crusher capacity, for the continuous use of a crusher plant the user will need and want a much lower crusher capacity than the crusher capacity provided by the known crusher plants, in order to keep the plant costs low.

### BRIEF DESCRIPTION OF THE FIGURES

The invention is described in more detail below with reference to the accompanying figures. The figures show a plurality of features of the invention in combination with one another. Of course, a person skilled in the art is also capable of considering said features separately from one another and of optionally combining them into further meaningful sub-combinations without having to exercise inventive skill for this purpose.

FIG. 1 shows an isometric view of the overall arrangement with a vibration conveyor device having only one vibrating trough.

FIG. 1a shows an embodiment according to the invention of the vibration conveyor device according to the frame A of FIG. 1.

FIG. 2 shows an isometric view of the vibration conveyor device of FIG. 1.

FIG. 3 shows an isometric view, rotated by 180°, of the vibration conveyor device according to FIG. 2.

FIG. 4 shows a front view of the vibration conveyor device of FIGS. 2 and 3.

FIG. 5 shows a front view of the vibration conveyor device of FIGS. 2 and 3 with an additional ramp.

FIG. 6 shows an isometric view of the vibration conveyor device according to embodiments the present invention.

### DETAILED DESCRIPTION

In order to be able to operate a corresponding crusher plant with a lower capacity, the paving stones and/or kerbstones which are to be crushed have to be separated. With the aid of this apparatus, the paving stones and/or kerbstones to be crushed are not only separated, but also aligned lengthwise. In this way, the plant can be dimensioned to be smaller and with a lower crushing capacity, since the starting material to be crushed can be supplied with a minimum predetermined cross section to the crusher. Owing to the longitudinal alignment, i.e. an alignment of the paving stones and/or kerbstones being crushed with their longest extent in the conveying direction, the predetermined cross section to be crushed of the stones to be crushed can be kept particularly small (minimal).

For example, in the case of conventional kerbstones to be crushed, the substantially rectangular cross section of the stones to be crushed is about 300 mm×150 mm, while the longitudinal extent can be, for example, 1000 mm long. Thus, the predetermined cross section of the starting material to be crushed can be limited, for example, to approximately 300 mm×300 mm, as a result of which the crusher capacity of the crusher can also be significantly reduced in comparison to the plants known from the prior art.

The term “kerbstone” used in the description and the claims also includes what are referred to as block steps here. The latter have a basic shape, which is comparable to kerbstones, with a comparatively large longitudinal extent compared to the edge lengths of the cross section, but have somewhat larger dimensions. For example, in the case of said kerbstones, the substantially rectangular cross section of the stones to be crushed is about 400 mm×150 mm, while the longitudinal extent can be, for example, 1200 mm long. Thus, the predetermined cross section of the starting material to be crushed can be limited, for example, to approximately 400 mm×400 mm, as a result of which the crusher capacity of the crusher can still be significantly reduced in comparison to the plants known from the prior art.

The apparatus according to the invention comprises at least one first crusher with driven crusher elements for crushing the paving stones and/or kerbstones to be crushed.

The at least one first crusher has a supply opening, via which the paving stones and/or kerbstones to be crushed can be supplied separately to the driven crusher elements. The supply opening and thus also the dimensioning of the associated crusher elements is significantly reduced in comparison to the prior art because of the minimal predetermined cross section of the stones to be crushed. Thus, in the above-described example, the supply opening may also substantially have a rectangular outline, which is slightly larger than the predetermined cross section of the starting material to be crushed, for example 350 mm×350 mm or the like.

The supplying, separating and aligning of the paving stones and/or kerbstones to be crushed is carried out by means of a vibration conveyor device, which supplies the paving stones and/or kerbstones, which are supplied as bulk material or as pallet goods and are to be crushed, in a conveying direction to the first crusher. In a known manner, the vibration of the vibration conveyor device supports the conveying and separation by the stones which are to be crushed being conveyed by the micro-throwing principle.

According to the invention, the vibration conveyor device comprises at least two vibrating troughs, which are arranged consecutively with respect to the conveying direction of the apparatus and define a trough-shaped receiving space for the paving stones and/or kerbstones to be crushed.

The vibrating troughs are thus cascaded, i.e. arranged in a plurality of successive steps, in order to increase the effect of the vibration conveyor device. The successive vibrating troughs of the vibration conveyor device jointly define the trough-shaped receiving space of the vibration conveyor device. Furthermore, each of the successive vibrating troughs of the vibration conveyor device can have a conveying direction assigned to it.

The first vibrating trough can receive the starting material to be crushed, convey it in a first conveying direction according to the above-described micro-throwing principle in the direction of the second vibrating trough and discharge it at one end into the second vibrating trough. The second vibrating trough is correspondingly loaded by the first vibrating trough.

In one conceivable embodiment, the at least two vibrating troughs can be designed and arranged with respect to one another in such a way that their respective conveying directions are aligned parallel to one another. The vibrating troughs are arranged virtually consecutively in a line and, in this embodiment, their central longitudinal axes can be arranged in alignment and can form a common central longitudinal axis of the vibration conveyor device.

Alternatively or additionally, a first vibrating trough of the at least two vibrating troughs can be arranged relative to a second vibrating trough of the at least two vibrating troughs in such a way that the first conveying direction of the first vibrating trough encloses a horizontal angle of incidence and/or a vertical angle of incidence with the second conveying device of the second vibrating trough.

In one possible embodiment, the vibration conveyor device thus comprises a plurality of, for example, two, vibrating troughs, which are arranged in succession such that the entire conveying direction of the vibration conveyor device can have a bend in the transition region of the vibrating troughs. This bend may be visible, as seen in a top view (horizontal angle of incidence) and/or, as seen in a side view (vertical angle of incidence), as explained in more detail below.

An advantageous solution is produced, for example, when the horizontal angle of incidence and/or the vertical angle of incidence between the first conveying direction and the second conveying direction comprises a predetermined angle of 0 to 120 angle degrees.

In particular, the cascaded vibrating troughs can be arranged with respect to one another in such a way that, as seen in a top view, the second conveying direction of the second vibrating trough is at a defined horizontal angle of incidence in an angular range of 0 to 120 angle degrees, in particular in an angular range of 10 to 115 angle degrees, for example, at virtually a right angle of 70 to 110 angle degrees, to the first conveying direction. This results in an at least partially asymmetrical construction of the trough-shaped receiving space formed by the cascaded vibrating troughs. As will be further explained below, such an asymmetrical construction supports an alignment of the paving stones and kerbstones to be crushed in the direction of the conveying direction of the apparatus.

A top view denotes a view in which vertical proportions of the conveying directions are ignored and the conveying directions are projected into a horizontal plane.

Alternatively or additionally, it is also possible that the conveying directions, as viewed in a lateral view, differ in the vertical direction due to different inclinations (slopes, in the conveying direction of the associated vibrating trough) of the first and second (downstream) vibrating trough and thus enclose a vertical angle of incidence between them. The vertical angle of incidence thus denotes the difference in the inclinations, which in particular can also in a desired way influence the micro-throwing initiated by the vibrating troughs. Accordingly, the vertical angle of incidence can be in particular in an angular range of 0 to 60 angle degrees, preferably in an angular range of 0 to 30 angle degrees, for example about 10 angle degrees.

A side view denotes a view in which horizontal proportions of the conveying directions are ignored and the conveying directions are projected into a vertical plane.

Alternatively or additionally, it is possible that the vibration conveyor device has a plurality of vibrating troughs which are consecutively arranged and which, with different conveying directions of vibration, convey the starting material to be crushed in the respective conveying direction.

Thus, a first vibrating trough can introduce a substantially vertical conveying direction of vibration (by means of vibrations with a substantially vertical vibration component) into the starting material, and the micro-throwing is essentially caused by the introduced vertical vibration and an angle of inclination of the first vibrating trough (gradient in the conveying direction of the first vibrating trough towards the second vibrating trough). The second or subsequent vibrating channel can, for example, introduce a vibration with an additional horizontal vibration component, i.e., for example, with an acceleration in the direction of the conveying direction, into the starting material. In this case, the conveying direction of vibration of the second vibrating trough then substantially differs from the conveying direction of vibration of the first vibrating trough.

In practice, it has been shown that, in particular when pouring in the starting material in the form of pallet goods to be crushed, a first vibrating trough initially primarily supports the separation of the starting material to be crushed, and the second vibrating trough, in particular by means of a bend in the joint receiving space (for example, a horizontal angle of incidence in the transition region from the first to the second vibrating trough), supports the desired alignment of the paving stones and/or kerbstones to be crushed.

Of course, more than just two vibrating troughs connected consecutively may also be provided, for example three, four or five vibrating troughs, if this is necessary and/or useful.

According to a development of the present invention, it can be provided that, with respect to a plane of symmetry spanned by the conveying direction and the direction of the acting weight force, the trough-shaped receiving space, which is defined by the vibrating troughs, introduces acceleration forces of differing size at least in certain sections into the paving stones and/or kerbstones to be crushed in order to align the latter with their longest extent substantially parallel to the conveying direction.

In this case, the term acceleration forces, in addition to positive acceleration forces, in particular also refers to negative acceleration forces, i.e. in certain sections braking or stopping the paving stones and/or kerbstones to be crushed, with a rotational movement being introduced into the rubble stones by the acceleration forces of differing size.

The conveying direction and the direction of the weight force acting on the stones together span a virtual plane of symmetry, wherein at least in certain sections on one side of this plane of symmetry greater acceleration forces are introduced into the paving stones and/or kerbstones to be crushed than on the other side. In this case, the virtual plane of symmetry may substantially coincide with the central longitudinal axis of the vibration conveyor device, in particular the central longitudinal axis of the trough-shaped receiving space, if the trough-shaped receiving space or the vibrating troughs of the vibration conveyor device extend along a common central longitudinal axis.

However, in the present case, vibration conveyor devices with a curved or bent trough-shaped receiving space are also covered by the present invention. If the vibration conveyor device and its trough-shaped receiving space extend along a curved or bent curve rather than along a straight line, the vibration conveyor device has not only a single virtual plane of symmetry, but a multiplicity of virtual planes of symmetry, which are spanned as indicated by the conveying direction at a point or region under consideration and by the weight force in the point or region under consideration.

In addition, the trough-shaped receiving space by means of its configuration according to the invention as a trough which extends in the direction of the conveying direction also supports the alignment of the starting material to be crushed along the conveying direction. In particular, kerbstones with a significantly larger longitudinal extent, if they are already dropping oriented in the desired manner into the trough-shaped receiving space, can remain aligned because of the trough shape, while kerbstones oriented transversely thereto are aligned by the introduced acceleration forces of differing size and the vibrations of the vibration conveyor device.

In a known manner, the vibrations of the vibration conveyor device cause micro-throwing of the starting material to be crushed into a micro-throwing movement. The paving stones and/or kerbstones to be crushed lift off briefly and move further in this way on a micro-throwing parabola in the conveying direction, until they then come back into contact with the vibration conveyor device again for a short time and are correspondingly accelerated again as a result of the vibrations.

By means of appropriate measures at the trough-shaped receiving space, in order to introduce acceleration forces of differing size at least in certain sections into the paving stones and/or kerbstones to be crushed, during each throw the acceleration forces of differing size can act correspondingly on the sections of the stones to be crushed that make contact transversely oriented (with respect to the conveying direction), as a result of which, for example, one end section (with respect to the longest extent) is accelerated or braked more sharply than the other.

As a corresponding measure, it can be provided that the trough-shaped receiving space for the paving stones and/or kerbstones to be crushed has an asymmetrical construction, with respect to the plane of symmetry, at least in certain sections. Such an asymmetrical construction can be expressed, for example, in an asymmetrical cross section or in individual elements, projections, structures or the like, which are provided in a certain region of the receiving space on one side (with respect to the plane of symmetry), but not on the other.

Thus, the vibration conveyor device can comprise at least one vibrating trough with at least two lateral guide walls extending along the conveying direction and a bottom wall. In this case, within the meaning of the asymmetrical construction of the trough-shaped receiving space, the first of the guide walls can enclose a first angle of incidence with the bottom wall, while the second of the guide walls encloses a second angle of incidence with the bottom wall, wherein the first angle of incidence and the second angle of incidence differ in size. The inclined lateral guide walls of the trough-shaped receiving space are used to hold stones that are already oriented in the desired way in the central region of the bottom wall and to secure them against rotating again. At the same time, acceleration forces of differing size are already introduced into transversely oriented stones by the different angles of incidence of the guide walls, and this, together with the vibrations of the vibration conveyor device, causes the alignment of these stones.

Vibrating troughs within the meaning of the present application may be substantially in the form of conveying troughs extending along a central longitudinal axis. However, even such embodiments may also be covered by the present definition of a vibration device having at least one vibrating trough, in which the vibrating trough(s) extends or extend along a curve. In this case, the conveying direction is also curved and the vibration conveyor device, as described above, may have a plurality of virtual planes of symmetry.

For an asymmetrical construction within the meaning of the present application, at least one of the vibrating troughs, which are formed consecutively, may for its part have an asymmetrical construction in such a way that the jointly formed receiving space has an asymmetrical structure at least in certain sections as a result.

The at least two vibrating troughs, which are arranged with respect to each other in such a way that the conveying directions thereof enclose a horizontal angle of incidence in an angular range of 0 to 120 angle degrees between them, together form a trough-shaped receiving space with a bend in the transition region from the first vibrating trough to the second vibrating trough.

The bend has a comparable effect to an asymmetrical cross section of the receiving space or the provision of individual elements, projections, structures or the like, which are provided in a certain region of the receiving space on one side (with respect to the virtual plane of symmetry), since the different conveying directions in the transition region lead to an asymmetrical introduction of acceleration forces onto the starting material to be crushed. In this way, at least in certain sections on one side of the assigned plane of symmetry, greater acceleration forces are introduced into the paving stones and/or kerbstones to be crushed than on the other side.

According to a development of the invention, it can be provided additionally or alternatively that the bottom wall of the trough-shaped receiving space, in particular of the at least one vibrating trough, has a width which at least approximately corresponds to one of the shorter edge lengths of the paving stones and/or kerbstones to be crushed. This in turn supports the fact that stones which are already aligned in the desired way can no longer be rotated after the alignment.

According to a development of the invention, it can be provided that the trough-shaped receiving space for the paving stones and/or kerbstones to be crushed is delimited by lateral guide walls which extend along the conveying direction and at least in certain sections introduce the acceleration forces of differing size into the paving stones and/or kerbstones to be crushed, in such a way that the vibration conveyor device is able to align the paving stones and/or kerbstones to be crushed with their longest extent substantially parallel to the conveying direction. In this configuration, the above-described asymmetrical construction of the receiving space can be provided. Alternatively, however, it is also possible by other measures to introduce the acceleration forces of differing size into the paving stones and/or kerbstones to be crushed.

For example, according to a development of the invention, the lateral guide walls on their respective surface which faces the paving stones and/or kerbstones to be crushed can have different coefficients of friction. This can be achieved, for example, in that they are provided with different material coatings or are produced from different materials. Of course, it is possible to provide only individual sections of the guide walls, for example, with a braking or accelerating coating, for example a rubber coating (braking), in order to introduce a negative (braking) or positive acceleration in this region into the sections of the stones to be crushed that come to lie on it, as a result of which an aligning rotational movement is achieved in them.

Alternatively or additionally, it is conceivable, according to a development of the invention, that at least one of the lateral guide walls on its surface facing the paving stones and/or kerbstones to be crushed has an alignment structure at least in certain sections. By means of such an alignment structure, increased friction, i.e. negative acceleration, of the contacting sections of the stones to be crushed can be achieved, which in turn has the above-described alignment effect.

According to a development of the invention, it can be provided that the alignment structure comprises at least one alignment member, in particular a ramp, a projection, a pin or the like, which protrudes from the respective guide surface into the receiving space. Such an alignment member is used in particular to set the rubble stones into a rotational movement and thus in turn to align them in a corresponding manner. In particular, the alignment structure may also have a plurality of alignment members. Furthermore, it can also be provided that not only one, but both lateral guide walls have a corresponding alignment structure, in particular at least one alignment member in each case, wherein, in this case, the alignment members are arranged offset to one another along the conveying direction such that the rubble stones cannot become jammed against them but rather instead support reliable rotation of the stones in the desired way.

Alternatively or additionally, the vibration conveyor device may have at least two hopper plates which delimit a hopper space between them and jointly form a discharging hopper which merges into the receiving space, wherein preferably at least one hopper plate is designed to be lowerable, in order, when required, to provide a filling region which permits filling of the hopper space by means of a bucket loader. In this case, the at least one lowerable hopper plate can be connected, for example, via a hinge connection to a guide wall of the vibration conveyor device and can be pivoted manually or by means of a drive unit between the lowered position and the hopper position. In principle, it is of course also possible to provide a translation movement instead of a pivoting movement for lowering the at least one hopper plate, for example by a relative displacement of the hopper plate, for example, in relation to a guide wall.

Of course, the at least two hopper plates can both also be designed correspondingly as lowerable hopper plates. In this way, the vibration conveyor device can be designed both for receiving (for example, on the rear side) pallet goods and, for example, for laterally receiving bulk goods by means of an excavator bucket.

As a drive unit or actuator, for example, a hydraulic cylinder can be provided with a piston rod which retracts into the cylinder in order to carry out the lowering movement.

In order to secure the position of the at least one lowerable hopper plate, one or more securing elements can furthermore also be provided, with, for example, hooks, bolts or the like being conceivable as securing elements.

Alternatively or additionally, it can be provided that at least one first conveyor device, in particular a driven belt conveyor, is provided between the vibration conveyor device and the first crusher. Such a belt conveyor can also comprise a screen-like belt as a conveyor belt in such a way that particles which are smaller than a predetermined grain size are screened out of the starting material to be crushed. It can thereby be prevented that too finely crushed material enters the crusher, if this is not desired. Alternatively, of course, any other type of conveyor systems with a corresponding screening device are conceivable as the first conveyor device, such as, for example, a conveyor belt, a conveyor chain, a vibration conveyor, a scraper floor conveyor, etc., provided that these are suitable for conveying stones to be crushed.

Furthermore, it can be provided that at least one metal detector is provided between the vibration conveyor device and the first crusher in order to detect any metal parts and, if a metal part is detected, to output a warning signal and/or to send a control signal to the first crusher and/or to another apparatus component.

In this way, the first crusher can be used with a comparatively low crusher capacity without at the same time having to accept the risk that small metal parts, such as screws, nuts or the like, will cause damage to the crusher or at least jamming of the crusher elements.

In the event of a metal part being detected, the metal detector can activate a downstream magnet that attracts any metal parts. Alternatively or additionally, the metal detector can trigger a shutdown of the crusher and/or a belt conveyor that passes the starting material to be tested through the metal detector. Of course, a warning signal can also be output that informs a user that a metal part has been detected, so that the user can additionally examine the starting material which is to be subsequently crushed.

Irrespective of the specific design of the vibration conveyor device and the possible provision of a metal detector, the supply opening of the first crusher may additionally have an input width of less than 750 mm, for example, as already mentioned above, an input width of, for example, 450 mm, 400 mm or possibly even only 350 mm. The width indicates the horizontal extent of the supply opening.

It can also be provided that the apparatus has at least one second crusher downstream of the first crusher in the conveying direction, wherein preferably at least one second conveyor device, in particular a driven belt conveyor, is provided between the first crusher and the second crusher. The same applies to the second conveyor device as explained above for a first conveyor device assigned to the first crusher.

The second crusher can be switched on and off on a case-by-case basis, in particular via a bypass.

Alternatively and additionally, it can be provided that the apparatus is received in a container, optionally in such a manner that the apparatus, when required, can be transported from one location to the other, wherein the container can be opened preferably on at least one side in order to fill the receiving space of the vibration conveyor device from the outside and/or in order to be able to remove the crushed material.

A substantial advantage of such a compact apparatus, which is received in a container, can be seen in particular in that within a virtually closed container (with, for example, only one open side) the production of dust during crushing and the noise emission are reduced. In particular, it can therefore be provided that the apparatus inside the container comprises a suction device, which is capable of extracting concrete dust arising during the crushing of the paving stones and/or kerbstones and/or comprises noise damping. For example, the inner walls may be lined with a noise-damping material or noise-damping elements may be provided inside the container.

Alternatively or additionally, the first crusher can comprise a crusher, in particular a jaw crusher, which is suitable for crushing the supplied paving stones and/or kerbstones into a crushed material with a grain size corresponding to a screen passage of a maximum of 30 mm, preferably a maximum of 12 mm. When an alternative crusher is used as the first crusher and in particular in combination with at least one downstream second crusher, the supplied paving stones and/or kerbstones and accordingly also the larger sized block steps can be crushed into a crushed material with a grain size corresponding to a screen passage of a maximum of 35 to 50 mm.

Furthermore, it can be provided that the second crusher comprises a crusher, in particular a roller crusher, which is suitable for crushing the crushed material supplied by the first crusher to a screen passage of a maximum of 12 mm, preferably a maximum of 7 mm, particularly preferably a maximum of 6 mm. In particular with regard to recycling the crushed material in the production of concrete, these grain sizes with a screen passage of a maximum of 12 mm, preferably a maximum of 7 mm, particularly preferably a maximum of 6 mm, have been tried and tested. When an alternative crusher is used as the second crusher and in particular in combination with the first crusher, the supplied paving stones and/or kerbstones and accordingly also the larger sized block steps can be crushed into a crushed material with a grain size corresponding to a screen passage of 2 mm to 5 mm.

Through the provision of a plurality of crushers which are connected consecutively, the individual crusher capacity of the first and second crusher can be further reduced. In addition, as mentioned, the grain sizes can also be further reduced and at the same time larger stones than the initial size to be crushed can be crushed, for example block steps with dimensions of approximately 150 mm×400 mm×1200 mm.

Through the provision of a plurality of crushers, for example, a first crusher with a larger input width than mentioned above, i.e. with an input width of more than 750 mm, can be provided. A correspondingly larger supply opening with an input width of, for example, 800 mm, but also of, for example, 500 mm or 600 mm, may also be suitable in particular to be able to accommodate larger-sized kerbstones (block steps) in at least one orientation, namely with their longest extent aligned substantially parallel to the conveying direction.

The invention also relates to a method for crushing paving stones and/or kerbstones made of bonded concrete elements by means of an apparatus, as described above, having the features of claim 16. This comprises in particular the steps of: supplying the paving stones and/or kerbstones to be crushed as bulk material, in particular via at least one discharging hopper; conveying, separating and aligning the paving stones and/or kerbstones, which are supplied as bulk material and are to be crushed, in a conveying direction by means of a vibration conveyor device; and crushing the paving stones and/or kerbstones to be crushed by means of at least one first crusher with driven crusher elements, wherein the crusher has a supply opening, via which the paving stones and/or kerbstones to be crushed are supplied separately to the driven crusher elements.

In addition, it should be noted that expressions such as “comprising”, “having” or “with” do not exclude any other features or steps. Furthermore, expressions such as “a” or “the” that refer in the singular to steps or features do not exclude a plurality of features or steps, and vice versa.

Further features and advantages of the invention emerge from the description below of an exemplary embodiment of the invention and from the dependent claims.

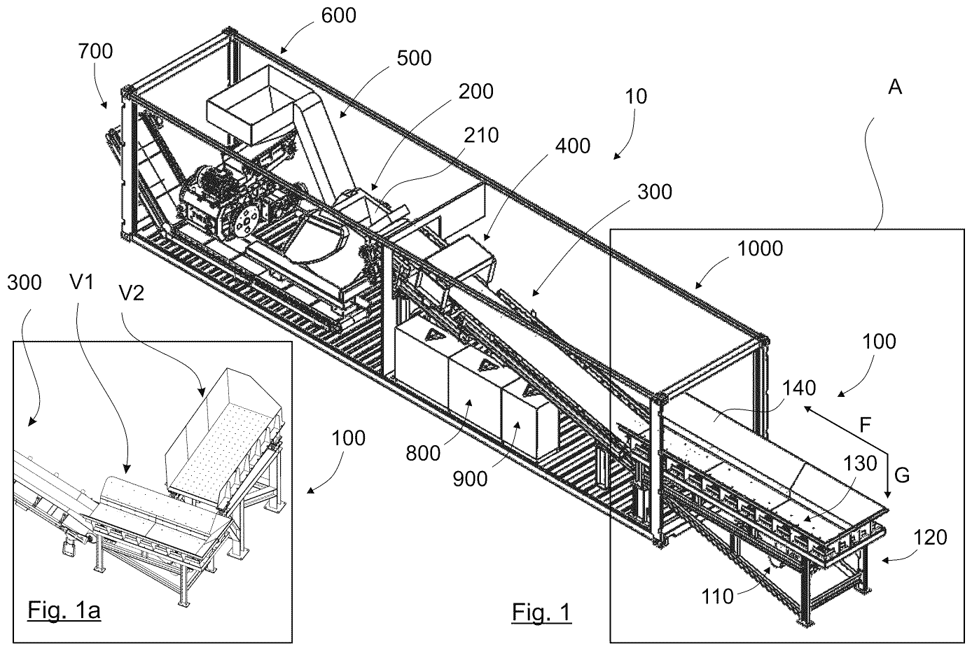

FIG. 1 shows an isometric view of the apparatus for crushing stones as an overall arrangement, which is denoted in general by the reference sign 10. In FIG. 1, a vibration conveyor device 100 having a single vibrating trough is shown in a framed region A. FIG. 1a additionally shows a vibration conveyor device 100 according to the invention having at least two vibrating troughs V1 and V2, which is integrated in the overall arrangement according to the invention of the apparatus 10 instead of the vibration conveyor device 100 of FIG. 1 (indicated by the framed region A).

In the embodiment shown in FIG. 1, the overall arrangement shows the vibration conveyor device 100 having a single vibrating trough, a first crusher 200 and a driven belt conveyor 300 arranged in between.

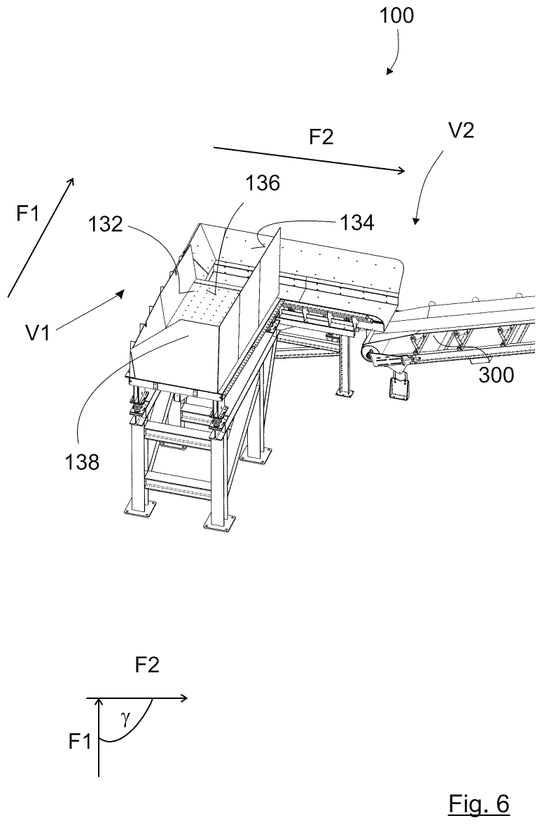

According to the invention, the overall arrangement according to FIG. 1 has the vibration conveyor device 100 having at least two vibrating troughs V1 and V2, as shown in FIGS. 1a and 6. This vibration conveyor device 100 according to the invention of FIGS. 1a and 6 is integrated in the overall arrangement of the invention according to FIG. 1 (indicated by the adjoining belt conveyor 300 in FIGS. 1a and 6) corresponding to the vibration conveyor device of FIG. 1 (cf. detail A). By means of the cascaded construction of the vibration conveyor device 100 having at least two vibrating troughs V1 and V2, as shown in FIG. 6, the effect of the vibration conveyor device 100 is significantly improved according to the invention.

In the illustration of FIG. 1, it is seen that the belt conveyor 300 passes through a magnetic detector 400, with the aid of which metal parts present in the starting material to be crushed can be determined.

The first crusher 200 breaks down the starting material to be crushed to a predetermined maximum grain size and outputs this at an output opening in a known manner. In the embodiment illustrated, the first crusher 200 is adjoined by a second crusher 600, which is supplied with the already pre-crushed crushed material via a second belt conveyor 500. In this case, the second crusher 600 serves to further break down the pre-crushed crushed material to an even smaller grain size, so that the final crushed material has a maximum grain size, which can pass through a screen passage of, for example, 12 mm, 7 mm or a maximum of 6 mm. The crushed material is then conveyed outwards by means of a third belt conveyor 700, for example into a designated container (not illustrated).

A special feature of the present invention can be seen in that the entire arrangement can be accommodated in a single container 1000. In the embodiment illustrated, the container walls are illustrated transparently so that the individual components are visible.

In the embodiment shown, the container is open on its front side and its rear side to feed the bulk material to be crushed and to discharge the crushed material. The container 1000 can be closed on the remaining sides, as shown. In this way, it is already possible to reduce the production of dust for the environment of the apparatus 10. In addition, in the interior of the container 1000 a suction device can be provided which is illustrated in a greatly simplified manner by a box 800 in the illustration of FIG. 1. Of course, such a suction device can also include suction elements which are arranged in the immediate vicinity of the heaviest production of dust within the container. However, such elements have been omitted in the schematic illustration of FIG. 1 in order to simplify the illustration.

A further advantage of the present invention, in particular of the configuration in which the entire apparatus can be accommodated in a container 1000, is that the production of noise of the apparatus can also be reduced by corresponding noise damping in the interior of the container. Such a coating can be achieved, for example, by a coating provided at least in certain sections of the inner surfaces of the container walls with a damping coating, for example with foam rubber or the like.

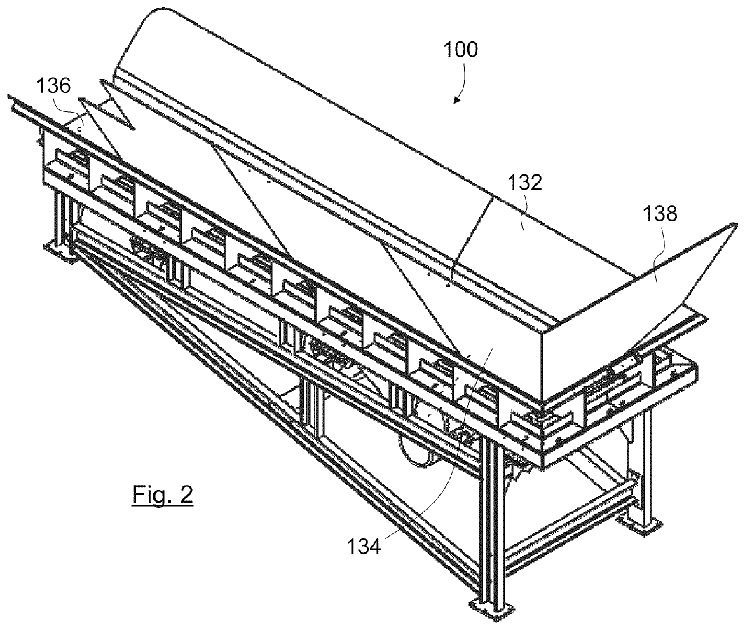

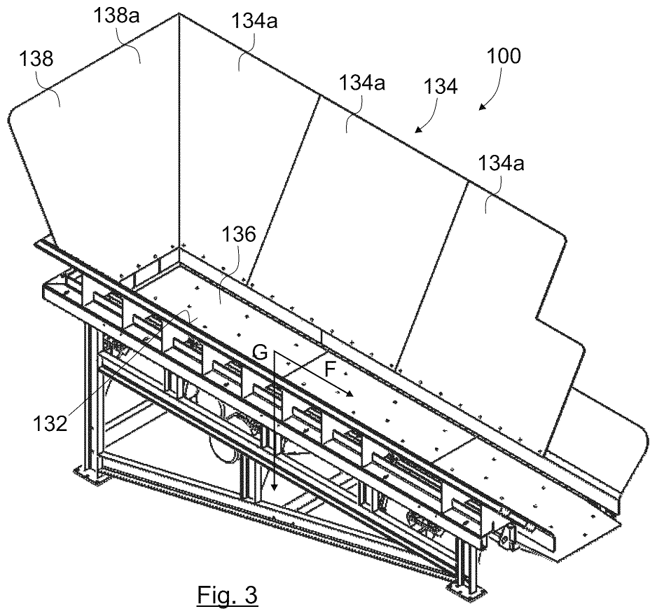

Another special feature of the present apparatus consists in the possible configuration described below at least one of the vibrating troughs of the vibration conveyor device, which is shown by way of example in FIGS. 2 to 5.

FIG. 6 shows the configuration according to the invention of the vibration conveyor device having at least two vibrating troughs V1 and V2, wherein at least one of the vibrating troughs can correspond to the embodiment of FIGS. 2 to 5. Furthermore, according to the invention, this configuration of the vibration conveyor device (according to FIGS. 1a and 6) having at least two vibrating troughs V1 and V2 is integrated instead of the vibration conveyor device of FIG. 1 in an overall arrangement of the invention according to FIG. 1 (indicated by the adjoining belt conveyor 300 in FIG. 6).

The vibration conveyor device 100 of FIG. 1 comprises a trough-shaped receiving space 130 on a vibrating trough, which is received on a support frame 120 and is set in a known manner into a vibrating movement via a vibration unit 110. By this means, the paving stones and/or kerbstones to be crushed (not illustrated), which are located in the trough-shaped receiving space 130, are conveyed in the direction of the first crusher 200 by means of the micro-throwing principle. For this purpose, the paving stones and/or kerbstones to be crushed are introduced into the receiving space 130 as bulk material as the starting material for crushing and separated with the aid of the vibration conveyor device 200.

In an analogous manner, the vibrating troughs V1 and V2 of the vibration conveyor device 100 of FIGS. 1a and 6 of the invention together form a trough-shaped receiving space 130, which may have a bend in the transition region of the vibrating troughs V1 and V2 depending on the arrangement of the vibrating troughs V1 and V2.

In order to be able to crush not only stones, the dimensions of which are similar in size in virtually all three spatial axes, with the first crusher 200, but also stones, for example, kerbstones, which have a significantly higher extent in a longitudinal direction (for example, 300 mm×300 mm×1200 mm) with the aid of the vibration conveyor device according to the present invention, the paving stones and/or kerbstones to be crushed can be aligned even with their longest extent substantially parallel to the conveying direction.

In this way, it is ensured that the stones to be crushed can be supplied with their smallest cross section through the supply opening 210 of the first crusher to the crusher elements accommodated therein (not illustrated). This makes it possible to use a first crusher 200 with a significantly lower crushing capacity than was previously the case in the prior art.

The alignment is achieved by various conceivable measures, which are capable of setting the paving stones and/or kerbstones which are to be crushed and are not correspondingly aligned, into a rotational movement to provide the corresponding alignment.

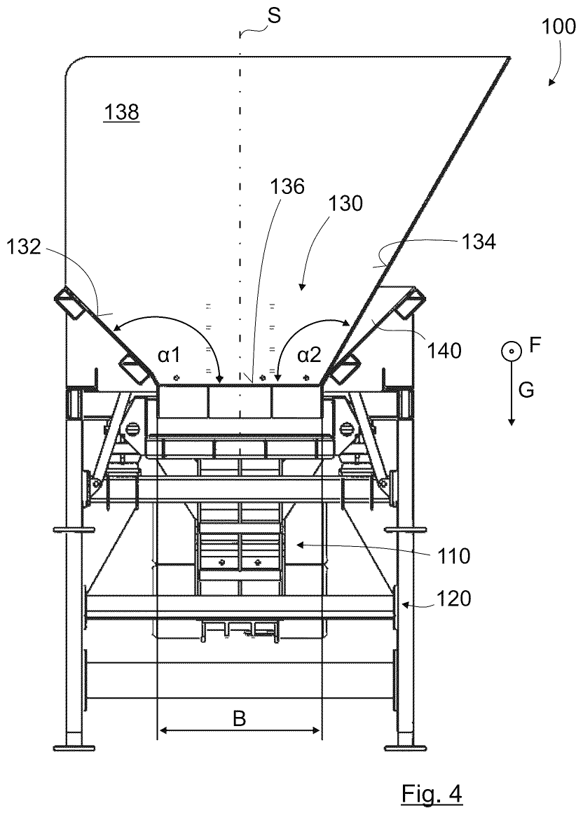

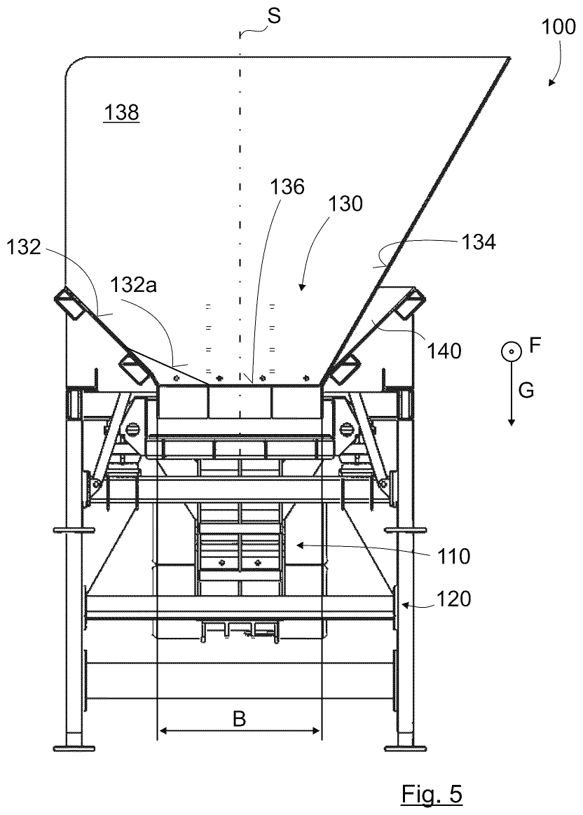

FIGS. 2 to 4 show one conceivable configuration variant of the present invention, but the invention is not limited to this one configuration variant, but rather comprises alternative or additional solution approaches. FIGS. 5 and 6 show further conceivable configuration variants in combination with the measure of FIG. 4, wherein these can also be implemented separately from said measure.

In the illustrated embodiment of FIGS. 2 to 4, the vibration conveyor device 100 comprises, in addition to a vibration drive 110, a trough-shaped receiving space 130, which can be formed by a plurality of components, as explained in more detail below. The receiving space 130 extends longitudinally in the conveying direction F and, in the embodiment illustrated, is delimited by a first guide wall 132, a second guide wall 134 and a bottom wall 136. Furthermore, an end wall 138 is provided which delimits the receiving space at a distal end (with respect to the first crusher 200).

The vibration conveyor device 100 according to the illustrated embodiment thus comprises a vibrating trough, wherein, in the illustrated embodiment, the at least one guide wall 134 and the end wall 138 are defined by means of additional plates (hereinafter also referred to as hopper plates). The guide wall 132, however, is formed by a side wall of the vibrating trough 140. In this case, the guide wall 132 encloses a first angle of incidence α₁ with the bottom wall 136. The second guide wall 134 formed by the hopper plates 134a is furthermore arranged on the second side wall of the vibrating trough 140 in such a way that it encloses a second angle of incidence α₂, which in the embodiment illustrated is smaller than the first angle of incidence α₁, with the bottom wall 136. In this way, by means of the arrangement of the hopper plates 134a, a receiving space 130 which is asymmetrical with respect to a plane of symmetry S (cf. FIG. 4) is formed. The plane of symmetry S denotes a virtual plane which is spanned by the conveying direction F and the weight force G and, in the embodiment shown, coincides with a central longitudinal axis of the vibration conveyor device 100.

It is seen in FIG. 4, for example, that the vibrating trough 140 has a substantially symmetrical construction with respect to the plane of symmetry S, which is modified by the inclined additional hopper plates 134a to form an asymmetrical construction of the receiving space of the vibration conveyor device 100.

As a result of this asymmetrical construction, acceleration forces or frictional forces of differing size are introduced by the guide walls 132, 134 into the stones to be crushed, which are poured as bulk material into the receiving space 130 of the vibration conveyor device 100. Thus, during each micro-throw (as a result of the vibrations of the vibration drive 110), a stone which is to be crushed and comes to lie with an end section on the first guide wall and with a second end section on the second guide wall 134, accelerates to differing extents at its two ends such that one end moves more rapidly in the conveying direction than the other. In this way, the desired alignment of the stones to be crushed is achieved with their longitudinal extent in the direction of the conveying direction. Furthermore, stones which already come to lie in the desired alignment in the trough-shaped receiving space 130 can be conveyed without additional further rotation in the conveying direction in the direction of the first crusher 200, in particular if the bottom wall 136 has a width B which substantially corresponds to the width of the stones to be crushed in one of the two shorter edge lengths (not the longitudinal extent).

If a complete alignment over the length of the vibration conveyor device 100 has not yet been carried out, at least one end section (with respect to the longitudinal axis and longitudinal extent of the stones to be crushed) first protrudes forward beyond the vibration conveyor device 100 in the direction of the belt conveyor 300 and comes into contact with the latter first. The driven belt conveyor 300 accelerates said end piece coming into contact and thereby supports the final alignment of the longitudinal extent in the conveying direction F.

Alternatively or additionally to the embodiment variant shown with an asymmetrical construction (in a cross-sectional view, for example as shown in FIG. 4, the cross-sectional view being oriented transversely to the conveying direction), further measures may be provided on the guide walls, which measures are capable of introducing acceleration forces of differing size into the stones to be crushed. One variant may, for example, consist in different coatings of the guide walls, wherein such coatings may also only be provided in certain sections on the guide walls. Another alternative solution can be introduced into the stones to be crushed by providing an alignment structure of acceleration forces differing in size. Thus, for example, on one of the guide walls an alignment structure with one or more alignment members or obstacles may be provided which are capable of braking stones to be crushed which make contact with them and of thereby introducing a rotational movement into them.

In combination with an asymmetrical configuration, this is shown by way of example in FIG. 5, wherein the guide wall 132 has an additional ramp 132a which, as a partial obstacle, can introduce a negative acceleration into the stones to be crushed. This measure which is illustrated by way of example as ramp 132a can of course also be provided on the other of the two guide walls or in the case of a vibrating trough with symmetrical construction.

It may also be provided that corresponding alignment structures are provided on both guide walls, wherein said alignment structures can then be arranged offset with respect to one another in the guide direction in such a way that, on the one hand, the stones to be crushed cannot become jammed between the alignment structures and, on the other hand, corresponding angular pulses cannot be introduced simultaneously but rather successively.

In addition, it is also conceivable that the bottom wall is provided with a special coating, which in particular supports low-friction conveying of the stones to be crushed, as a result of which stones to be crushed which are already aligned as desired can be conveyed more rapidly forward.

As already indicated by the name, the hopper plates 134a serve not only to form a steeper guide wall 134 in relation to the flatter guide wall 132 (in the embodiment illustrated), but also to form a hopper, together with the hopper plate 138a forming the end wall. Via the flatter guide wall 132, the material to be crushed can be tipped in, for example, with a forklift truck or a tipper loader. The first guide wall 132 thus forms the filling side or the filling region.

Furthermore, at least one of the hopper plates 134a, 138a can be designed to be lowerable and/or pivotable if, on a case-by-case basis, loading from the rear and/or from the other side is desired. In particular, if the paving stones and/or kerbstones which are to be crushed and are in the form of pallet goods are to be tipped in, it is advantageous if at least one or both hopper plates 134a, 138a are designed to be lowerable and/or pivotable to enable better accessibility to the receiving space.

In FIGS. 1a and 6, a vibration conveyor device 100 according to the invention is shown, which comprises a plurality of vibrating troughs V1 and V2 arranged consecutively. The vibrating troughs V1 and V2 are arranged in cascaded form and thus increase the effectiveness of the vibration conveyor device 100.

The first vibrating trough V1 corresponds in its construction substantially to the vibrating trough according to FIGS. 2 to 4 or FIG. 5, which is why reference is made to the more detailed description of the individual components of the vibrating trough according to FIGS. 2 to 4 or FIG. 5.

Furthermore, the vibrating trough V1 for aligning the paving stones and/or kerbstones to be crushed may have an asymmetrical construction of whatever kind according to the above statements regarding FIGS. 2 to 5. In the same way, alternatively or additionally, the vibrating trough V2 for aligning the paving stones and/or kerbstones to be crushed may have an asymmetrical construction of whatever kind according to the above statements regarding FIGS. 2 to 5.

However, these above-described measures for aligning the paving stones and/or kerbstones to be crushed according to the embodiments of FIGS. 2 to 5 can also be dispensed with. In such a case, the alignment of the paving stones and/or kerbstones to be crushed can be effected by the specific arrangement of the first vibrating trough V1 relative to a second downstream vibrating trough V2, as will be explained in more detail below.

In FIG. 6, it is seen that the second vibrating trough V2 can at least dispense with the additional hopper plates 134a, 138a, since the loading takes place via the first vibrating trough V1 leading into the second vibrating trough V2.

As explained above, a special feature according to the invention of the vibration conveyor device 100 of FIG. 6 can be seen in the cascading of a plurality of vibrating troughs, in the illustration shown of the vibrating troughs V1 and V2.

As already indicated, in addition to the cascading of the vibrating troughs V1 and V2 of the vibration conveyor device 100, a further special feature of this embodiment can be seen in the specific arrangement of the vibrating troughs V1 and V2 relative to each other. In a top view of the apparatus 10, i.e. viewed from above, the vibrating troughs V1 and V2 are arranged at virtually a right angle to each other in such a way that the first conveying direction F1 of the first vibrating trough V1 encloses a horizontal angle of incidence of approx. 90 angle degrees with the second conveying direction F2 of the second vibrating trough V2. Of course, a value differing therefrom for the horizontal angle of incidence can also be selected within a conceivable value range of 0 to 120 angle degrees.

This specific arrangement having a horizontal angle of incidence has a comparable effect as an asymmetrical cross section of the receiving space of the vibration conveyor device or the provision of individual elements, projections, structures or the like, which are provided in a certain region of the receiving space on one side (with respect to the virtual plane of symmetry). Thus, the different conveying directions F1 and F2 in the transition region from the vibrating trough V1 to the second vibrating trough V2 lead to an asymmetrical introduction of acceleration forces to the starting material to be crushed. In this way, at least in certain sections on one side of the plane of symmetry, greater acceleration forces are introduced into the paving stones and/or kerbstones to be crushed than on the other side.

Furthermore, although not shown, it is conceivable that the vibrating troughs V1 and V2, in a lateral view of the apparatus 10, i.e. viewed from the left or right side, are arranged at virtually an angle of incidence to each other in such a way that the associated conveying directions F1 and F2 are not parallel at an angle of incidence greater than 0 angle degrees. This means that one of the vibrating troughs V1 and V2 has a greater inclination (gradient) than the other, with the difference in the inclinations corresponding to the vertical angle of incidence between the two conveying directions. Accordingly, the first conveying direction F1 of the first vibrating trough V1 can in particular enclose a vertical angle of incidence of 0 to 60 angular degrees with the second conveying direction F2 of the second vibrating trough V2.

Furthermore, it has been shown in practice that paving stones and/or kerbstones supplied in particular as pallet goods are initially predominantly separated in the first vibrating trough V1 before an alignment of the individual paving stones and/or kerbstones takes place. Thus, the bend formed in a by the angle of incidence of the vibrating troughs V1 and V2 in the receiving space, defined by the cascaded vibrating troughs V1 and V2, of the vibration conveyor device is advantageous, since by this means the acceleration forces (as a result of the conveying direction F2 of the second vibrating trough V2, which is at a right angle in the example shown) on sections of the paving stones and/or kerbstones to be crushed and protruding therein correspondingly asymmetrically accelerate said sections and accordingly carry them along in the conveying direction F2.

In practice, it has also proved advantageous that consecutively arranged vibrating troughs V1 and V2 with different conveying directions of vibration convey the starting material to be crushed in the respective conveying direction F1 and F2.

Thus, the first vibrating trough V1 can introduce a substantially vertical conveying direction of vibration (upwards and downwards) into the starting material, and the micro-throwing is substantially caused by the introduced vertical vibration and an angle of inclination of the first vibrating trough (gradient in the conveying direction of the first vibrating trough towards the second vibrating trough). The second or subsequent vibrating trough V2 can, for example, introduce a vibration with an additional horizontal vibration component, i.e., for example, with an acceleration in the direction of the conveying direction F2, into the starting material. In this case, the conveying direction of vibration of the second vibrating trough V2 is then substantially horizontal.

Of course, according to the invention, more than just two vibrating troughs connected consecutively may also be provided, for example three, four or five vibrating troughs, if this is necessary and/or useful.

Overall, the arrangement shown permits continuous crushing of accruing rubble stones, such that temporary storage of the stones to be crushed over a relatively long period of time and storage of the rubble material over a relatively long period of time after crushing is not necessary, as a result of which the disadvantages described at the beginning and resulting therefrom can be avoided. At the same time, by means of the configuration of the vibration conveyor device, the plant can be used with a comparatively low power, since the stones to be crushed can be supplied with their smallest edge dimensions in cross section to the first crusher. Accordingly, the first crusher can be used with a comparatively small supply opening and consequently lower crushing capacity than is known from the prior art. Additional features, such as an optional belt conveyor, a metal detector and the arrangement of two crushers, enable the system to be further optimized. The provision of the entire apparatus in a container also enables the crushing process to be carried out with little dust and reduced noise, which is particularly advantageous if this is to be used in the vicinity of residential areas.

1-16. (canceled)

17. An apparatus for crushing paving stones and/or kerbstones, in particular made of concrete or concrete-like material, the apparatus comprising:
at least one first crusher with driven crusher elements for crushing the paving stones and/or kerbstones to be crushed, wherein the crusher has a supply opening, via which the paving stones and/or kerbstones to be crushed are to be supplied separately to the driven crusher elements; and
at least one vibration conveyor device, which is assigned to the first crusher and is intended for conveying and separating the paving stones and/or kerbstones, which are supplied as bulk material and are to be crushed, in a conveying direction,
wherein the vibration conveyor device comprises at least two vibrating troughs, which are arranged consecutively with respect to the conveying direction of the apparatus and define a trough-shaped receiving space for the paving stones and/or kerbstones to be crushed.

18. The apparatus of claim 17, wherein a first vibrating trough of the at least two vibrating troughs is arranged relative to a second vibrating trough of the at least two vibrating troughs in such a way that the first conveying direction of the first vibrating trough encloses a horizontal angle of incidence with a second conveying device of the second vibrating trough.

19. The apparatus of claim 18, wherein the horizontal angle of incidence between the first conveying direction of the first vibrating trough and the second conveying direction of the second vibrating trough comprises a predetermined angle in an angular range of 0 to 120 degrees.

20. The apparatus of claim 17, wherein a first vibrating trough of the at least two vibrating troughs is arranged relative to a second vibrating trough of the at least two vibrating troughs in such a way that the first conveying direction of the first vibrating trough encloses a vertical angle of incidence with a second conveying device of the second vibrating trough.

21. The apparatus of claim 20, wherein the vertical angle of incidence between the first conveying direction of the first vibrating trough and the second conveying direction of the second vibrating trough comprises a predetermined angle in an angular range of 0 to 120 degrees.

22. The apparatus of claim 17, wherein the vibration conveyor device has a plurality of vibrating troughs which are consecutively arranged and which, with different conveying directions of vibration, convey a starting material to be crushed in the respective conveying direction.

23. The apparatus of claim 17, wherein with respect to a plane of symmetry spanned by the conveying direction and the direction of the acting weight force, the trough-shaped receiving space introduces acceleration forces of differing size at least in certain sections into the paving stones and/or kerbstones to be crushed, in such a way that the vibration conveyor device is configured to align the paving stones and/or kerbstones to be crushed with their longest extent substantially parallel to the conveying direction.

24. The apparatus of claim 23, wherein the trough-shaped receiving space for the paving stones and/or kerbstones to be crushed has an asymmetrical construction at least in certain sections with respect to the plane of symmetry.

25. The apparatus of claim 23:
wherein the vibration conveyor device comprises at least one vibrating trough with at least two lateral guide walls extending along the conveying direction and a bottom wall,
wherein the first of the guide walls encloses a first angle of incidence with the bottom wall,
wherein the second of the guide walls encloses a second angle of incidence with the bottom wall, and
wherein the first angle of incidence and the second angle of incidence differ in size.

26. The apparatus of claim 17, wherein the bottom wall of the trough-shaped receiving space, in particular of the at least one vibrating trough, has a width which at least approximately corresponds to one of the shorter edge lengths of the paving stones and/or kerbstones to be crushed.

27. Apparatus according to claims 23, wherein the trough-shaped receiving space for the paving stones and/or kerbstones to be crushed is delimited by lateral guide walls which extend along the conveying direction and at least in certain sections introduce the acceleration forces of differing size into the paving stones and/or kerbstones to be crushed, in such a way that the vibration conveyor device is able to align the paving stones and/or kerbstones to be crushed with their longest extent substantially parallel to the conveying direction.

28. The apparatus of claim 27, wherein the lateral guide walls on their surface which faces the paving stones and/or kerbstones to be crushed have different coefficients of friction at least in certain sections.

29. The apparatus of claim 17, wherein at least one first conveyor device, in particular a driven belt conveyor, is provided between the vibration conveyor device and the first crusher.

30. The apparatus of claim 17, wherein at least one metal detector is provided between the vibration conveyor device and the first crusher in order to detect any metal parts and, if a metal part is detected, to output a warning signal and/or to send a control signal to the first crusher and/or to another apparatus component.

31. The apparatus of claim 17, wherein the apparatus has at least one second crusher downstream of the first crusher in the conveying direction, and wherein at least one second conveyor device, in particular a driven belt conveyor, is provided between the first crusher and the second crusher.

32. The apparatus of claim 17, wherein the apparatus is received in a container, wherein the container can be opened on at least one side in order to fill the receiving space of the vibration conveyor device from the outside and/or in order to be able to remove the crushed material, and wherein the apparatus inside the container comprises a suction device, which is configured to extract concrete dust arising during the crushing of the paving stones and/or kerbstones.

33. The apparatus of claim 32, wherein the suction device comprises noise dampening.

34. The apparatus of claim 17, wherein the first crusher comprises a crusher, in particular a jaw crusher, which is configured for crushing the supplied paving stones and/or kerbstones into a crushed material with a grain size of a maximum of 30 mm, preferably a maximum of 12 mm, and/or wherein a second crusher comprises a crusher, in particular a roller crusher, which is configured for crushing the crushed material supplied by the first crusher to a screen passage of a maximum of 12 mm, preferably a maximum of 7 mm, particularly preferably a maximum of 6 mm.

35. A method for crushing paving stones and/or kerbstones made of bonded concrete elements by means of the apparatus of claims 17, wherein the method comprises:
supplying the paving stones and/or kerbstones to be crushed as bulk material;
conveying, separating and aligning the paving stones and/or kerbstones, which are supplied as bulk material and are to be crushed, in a conveying direction by means of a vibration conveyor device; and
crushing the paving stones and/or kerbstones to be crushed by means of at least one first crusher with driven crusher elements, wherein the crusher has a supply opening, via which the paving stones and/or kerbstones to be crushed are supplied separately to the driven crusher elements;
wherein the vibration conveyor device comprises at least two vibrating troughs, which are arranged consecutively with respect to the conveying direction of the apparatus and define a trough-shaped receiving space for the paving stones and/or kerbstones to be crushed.
